(19) United States
(12) Patent Application Publication
(10) Pub. No.: US 2018/0319494 A1
(43) Pub. Date: Nov. 8, 2018

(54) UNMANNED AERIAL ROADSIDE ASSIST SYSTEM

(71) Applicant: Kamran Aflatoon, Corona del Mar, CA (US)

(72) Inventor: Kamran Aflatoon, Corona del Mar, CA (US)

(21) Appl. No.: 15/970,621

(22) Filed: May 3, 2018

Related U.S. Application Data
(60) Provisional application No. 62/500,697, filed on May 3, 2017.

(51) Int. Cl. B64C 39/02; B64C 27/08

(52) U.S. Cl. CPC B64C 39/02; B64C 27/08; B64C 2201/126; B60L 11/1822; B64C 2201/127; B64C 2201/18; B64C 2201/145

(57) ABSTRACT

A roadside assistance system for motorists, comprising a plurality of unmanned aerial vehicles (UAVs) each having an emergency battery power supply connected to an inductive charger, an emergency detachable fuel supply, an imaging system and a visual landing software module configured to land the UAV on a predetermined target. In addition, each has an inductive charging pad electrically connected to a vehicle electrical system, the inductive charging pad bearing the predetermined to by which the UAV may deliver a charge necessary to jump a vehicle or provide an emergency recharge.

### CROSS-REFERENCE TO RELATED APPLICATION(S)

The present application derives priority from U.S. provisional application Ser. No. 62/500,697 filed 3 May 2017.

### BACKGROUND OF THE INVENTION

### 1. Field of the Invention

The present in relates generally to unmanned aerial chides (UAVs) and more specifically to a system for deploying roadside assistance to motorists by UAVs.

### 2. Description of the Background

Stranded motorists in need of roadside assistance typically rely on service providers such as AAA to dispatch mechanics and tow operators. The current process is inefficient and often frustrating as the motorist most wait for a tow vehicle that is often subject to road and traffic conditions, especially in congested areas, and sometimes it takes hours. Often all the motorist needs is a small amount of gasoline or a jump start, or in the case of electric vehicles a charge.

Unmanned Aerial Vehicles (UAVs) are increasingly being used for delivery of packages and consumer goods via land-based methods that require using a land-based vehicle to carry the goods to the consumer. For example, Amazon® has proposed a drone delivery system that uses a UAV delivery vehicle not subject to road and traffic conditions, and able to deliver small packages to consumers in minutes. The Amazon drone delivery system uses on-board GPS guidance for its unmanned aerial vehicle.

Many other unmanned UAVs have been developed for a variety of purposes, including military and recreational uses, including some that can be controlled with a cell phone. The few that have been designed for delivery of consumer goods, such as the Amazon delivery drone, are limited in their navigation capabilities, especially their ability to avoid obstacles and ensure that only the intended recipient can access the goods. The roadside assistance industry present a unique set of circumstances some that facilitate UAV use, and some that raise obstacles.

Stranded motorists are stationary and typically have smart phones with location services capable of pinpointing their location. If all they need is a small quantity of gasoline or a jump start or recharge it would seem far more efficient to send a UAV. This would avoid the long wait or a tow vehicle and poor traffic conditions. However, the problem remains how to deliver the service on arrival. The GPS coordinates are accurate enough to guide the UAV to land near the vehicle, and UAV payloads have increased to the point where they are capable of transporting a small container of gas and a battery pack sufficient to jump a car or charge an electric vehicle. Unfortunately most motorists are not capable of retrieving the gas and/or battery pack and connecting it properly to their vehicle.

It would be advantageous to provide a UAV system capable of solving the foregoing problem by delivering gas and autonomously jumping and/or charging the vehicle with minimal motorist-assistance, and to that end providing interactive assistance and feedback to the motorist on their cell phone.

### SUMMARY OF THE INVENTION

It is, therefore, an object of the present invention to provide a system for dispatching roadside assistance to motorists using a network of unmanned aerial vehicles (UAVs). A motorist in need of roadside assistance and particularly a battery boost requests a dispatch using an application running on their smart phone. The application transmits a request to a service provider including the nature of assistance required and current GPS coordinates. The service provider dispatches the most proximate UAV to the motorist from a network of UAVs. Each UAV in the network is dispatched and controlled from a remote server to follow a flight plan to the summoning motorist based on GPS location of their cell phone. Control is then transferred to the UAV which is equipped with a visual landing program that lands on the vehicle, preferably on a landing pad placed there by the motorist or alternatively on the cell phone. The landing pad doubles as an inductive charging station that uses an electromagnetic field to transfer energy to the vehicle by electromagnetic induction. Alternatively, the motorist is instructed via their cell phone how to connect cables. The motorist application also provides a direct videoconferencing feature to establish a direct two-way videoconference between the remote service provider and the motorist cell phone, for two way live communication with a mechanic. Either way the UAV delivers the charge necessary to jump the vehicle or provide an emergency recharge to its batteries. The UAV may also be equipped with a small fuel reservoir and the motorist is instructed via their cell phone how to refuel and start a vehicle that has run out of gas. The UAV may also be equipped with a small reservoir for radiator fluid and the motorist is instructed via their cell phone how to fill the vehicle radiator that has overheated. The UAV may also be equipped with a tire inflator and the motorist is instructed via their cell phone how to inflate a flat tire.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of a stranded motorist in need of roadside assistance. particularly a jump start for a conventional car or a battery boost for an electric-powered car, requesting a dispatch using an application running on their smart phone 10.

FIG. 2 illustrates an example network environment for implementing the present system.

FIG. 3 is a screenshot of the roadside assistance mobile application used in implementing the present system.

FIG. 4 is a perspective view of an exemplary charging pad 50 adhered exteriorly to the roof of vehicle 20.

FIG. 5 is a simplified block diagram illustrating components of a UAV 4 used in the present system.

### DETAILED DESCRIPTION OF THE PREFERRED EMBODIMENT

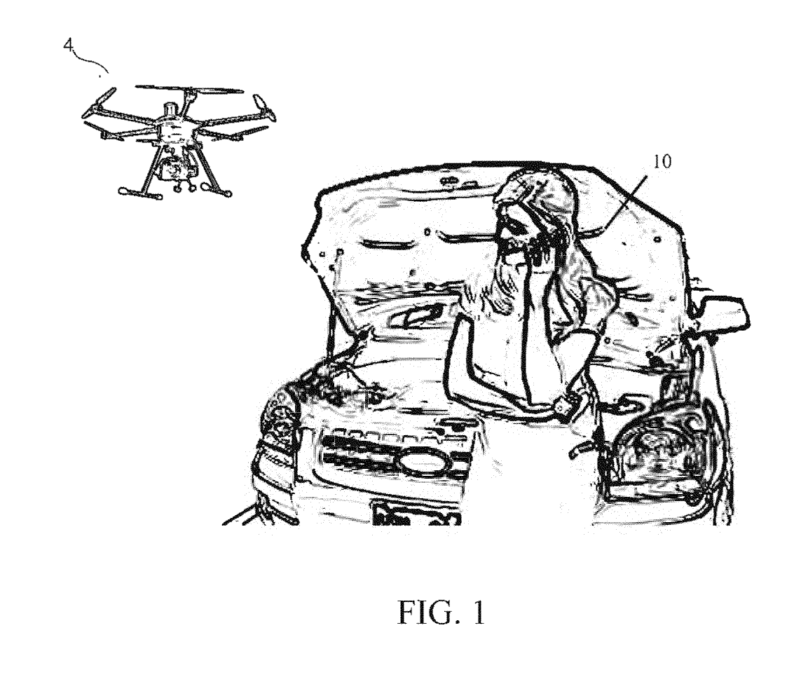

The present invention is a system for dispatching roadside assistance to motorists using a network of unmanned aerial vehicles (UAVs). As seen in FIG. 1, a stranded motorist in need of roadside assistance, particularly one who has run out of gas or needs an emergency jump start for a conventional car or a battery boost for an electric-powered car, requests a dispatch using an application running on their smart phone 10. The application transmits a request to a service provider including subscriber ID, chicle ID, the nature of assistance required, and current GPS coordinates. The service provider dispatches the most proximate UAV 4 to the motorist from a network of UAVs. Each UAV 4 in the network is equipped with an emergency fuel container and a lithium ion battery jumper pack for conventional car batteries, plus an inductive charger for a spot charge of electric vehicles. In an embodiment, the UAV auto-navigates over the vehicle by GPS then uses visual navigation to land on the vehicle, preferably on an inductive charging pad mounted on the vehicle by which it charges or jumps the vehicle. Alternatively, the lithium ion battery pack may be detached from the UAV 4 and used to jump the ignition in a conventional manner.

The system described herein is deployed by a service provider company to perform roadside assistance for subscribers who have an account with the service provider company. Although many examples herein will be described as being used in conjunction with a service provider company, the systems and methods described herein may be used by or with other entities or types of entities without departing from the spirit of the disclosure.

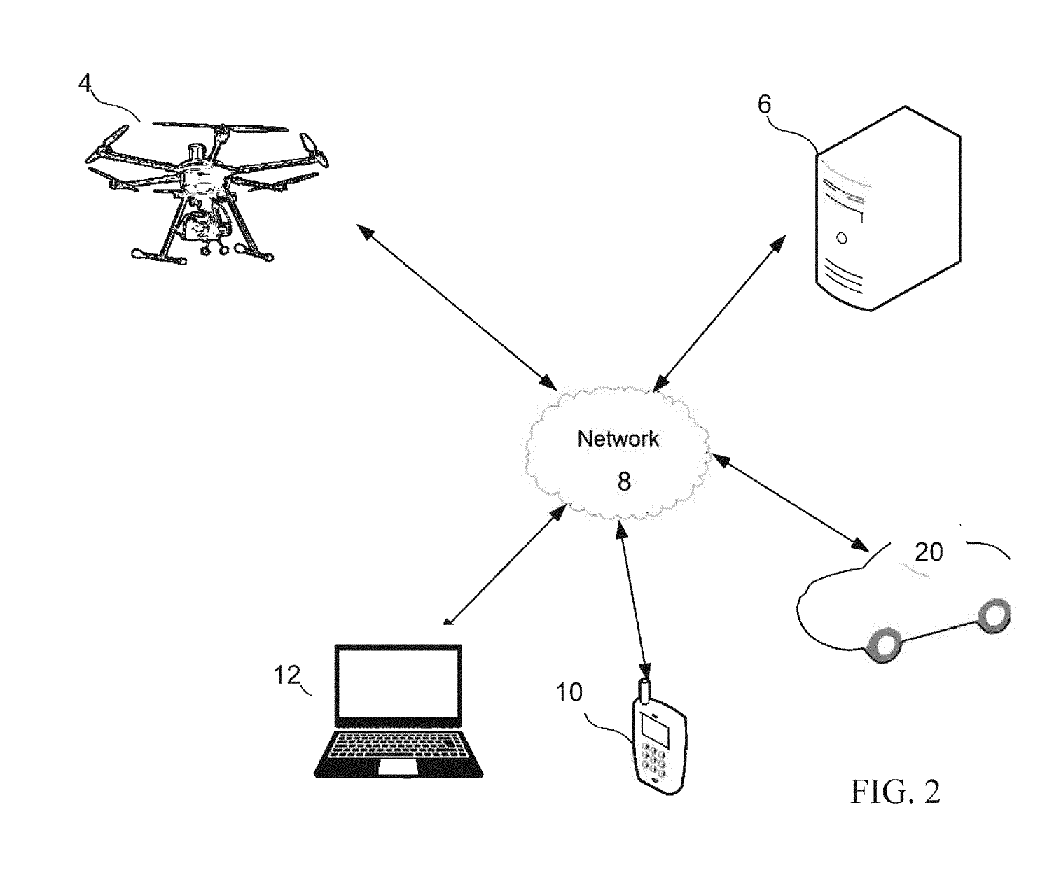

FIG. 2 illustrates an example network environment for implementing the present system. As shown in FIG. 2, the network environment may include a network S configured to connect to a UAV 4, roadside assistance server 6, computing device 12, mobile device 10, and vehicle 20. The network 8 preferably includes a cellular network and its components, such as cell towers, with a mobile broadband connection for wireless Internet access through mobile devices. Accordingly, for example, a mobile device 10 (e.g., a smartphone) or other portable computing device 12 of an individual associated with vehicle 20 may communicate, via a cellular with the network 8, with an roadside assistance server 6 to send a roadside assistance request for one or more individuals associated with the vehicle 20. In another example, the mobile device 10 of the individual associated with vehicle 20 may communicate, via cellular to the network 8, with the roadside assistance server 6 to transmit a dispatch request.

Although FIG. 2 depicts the vehicle 20 as a car, the vehicle 20 may be any type of vehicle, including a motorcycle, bicycle, scooter, snowmobile, UAV (or other automated device), truck, bus, train, commercial vehicles, tractor, moped, off-road vehicle, caravan, recreational vehicle, boat, ship, other marine vehicles, plane, helicopter, tank, airplane carrier, battleship, other military vehicles, and the like.

The smart device 10 runs a roadside assistance mobile application that generates a user interface (e.g., a graphical user interface) to allow individuals to send dispatch requests and receive status updates. An individual may launch the roadside assistance mobile application on their mobile device 10 by, for example, operating buttons or a touchscreen on the mobile device 10. Additionally, or alternatively, the mobile device 10 may be configured to execute a web browser (e.g., an application for accessing and navigating the Internet) to access a web page providing an interface for the roadside assistance mobile application. The roadside assistance mobile application installed on the mobile device 10 may instruct the mobile device 10 to poll its location services to collect UPS coordinates, indicating the geographical location of the mobile device 10 and/or vehicle 20. This way, the roadside assistance server 6 identifies the precise location of the mobile device 10 by receiving position information.

An individual associated with the vehicle 20 and the mobile device 10 may transmit a dispatch request at the mobile device 10 by accessing the roadside assistance mobile application. By gathering subscriber data inputted from the mobile application and the UPS location of the device 10, the roadside assistance server 6 may have access to account information, billing information, and location information of the user of the mobile application associated with the vehicle 20.

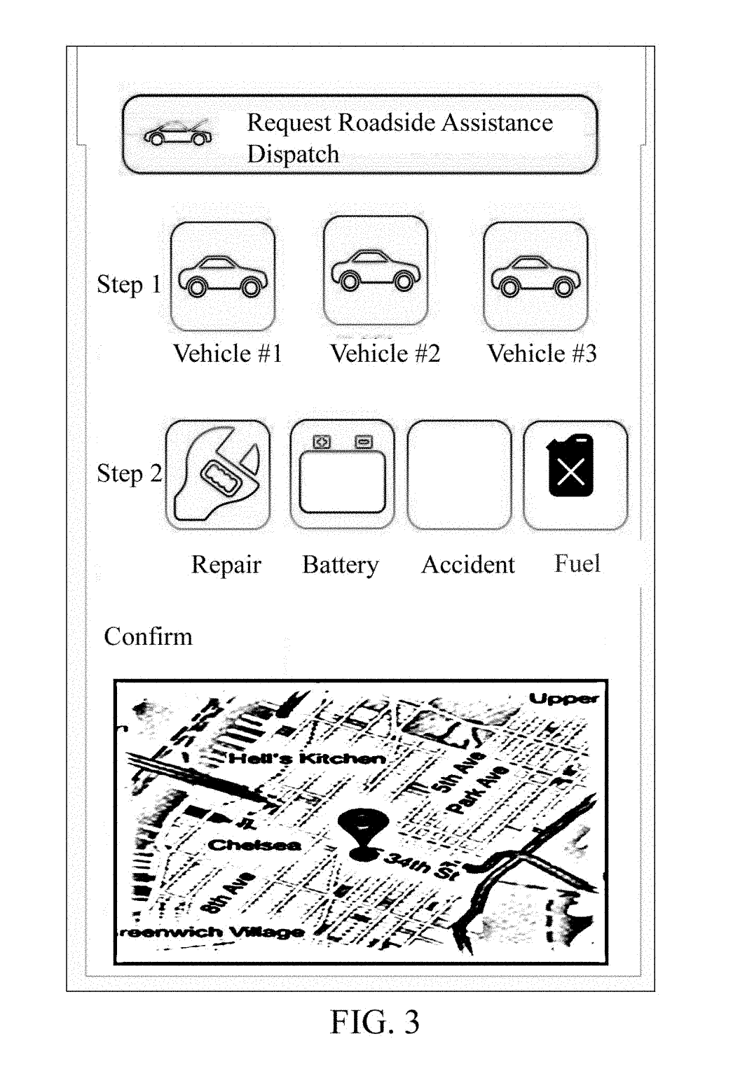

FIG. 3 is a screenshot of the roadside assistance mobile application. The user interface compels user selection of the vehicle (step 1), and the nature of assistance needed (step 2). Upon making these selections and pressing the dispatch button the smart phone sends the information along with GPS coordinates from the smart phone's location services, and subscriber ID, to the service provider central server 6.

Upon receiving and processing a dispatch request, the roadside assistance server 6 may identify and authenticate the subscriber and the vehicle 20 associated with the roadside dispatch request. The roadside assistance server 6 returns a notification to the subscriber through the mobile roadside assistance application, text message, email, or a phone call to the mobile device 10 to confirm receipt and a pending dispatch.

Upon receipt of a dispatch request from a subscriber, the roadside assistance server 6 automatically calculates the closest UAV 4 in the network to the GPS location, compiles a flight plan, and dispatches a UAV 4 to the location. The roadside assistance server 6 may calculate a trajectory for the UAV 4 to the location by creating a flight trajectory avoiding an obstacles such as buildings or electrical wires. The roadside assistance server 6 downloads the flight plan to the memory of the UAV 4 as a backup, but generally maintains communication with the UAV 4 executing the flight plan at the roadside assistance server 6 and transmitting controls to the UAV 4 to execute. If communication is temporarily lost the UAV 4 will execute the flight plan locally until communications resume.

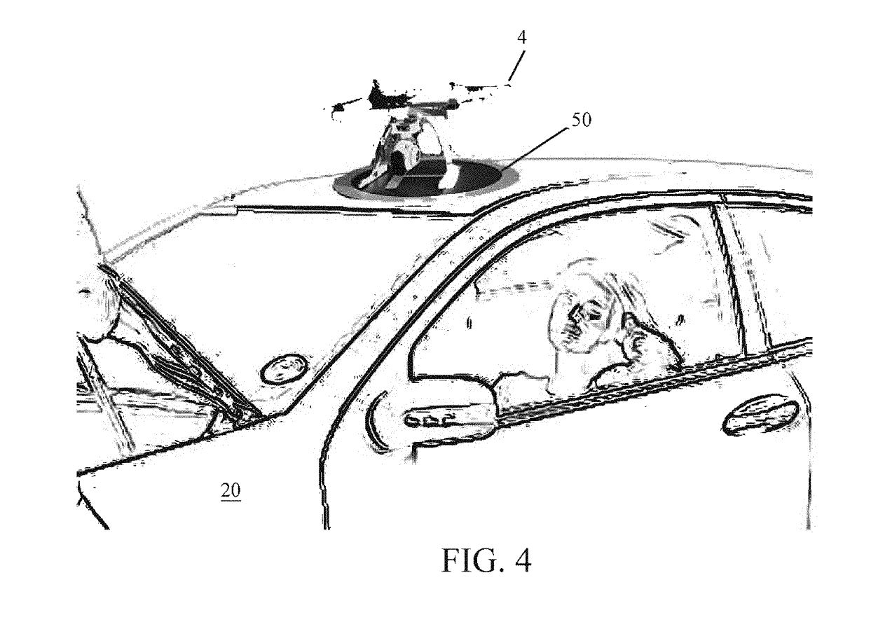

When the UAV 4 arrives, the roadside assistance server 6 relinquishes control to the UAV 4 which executes a visual landing protocol, initially requiring it to hover over the vehicle until it identifies a predetermined visual target to land on. A method to land the UAV 4 on the vehicle target may be provided in accordance with an embodiment of the invention. In an embodiment, subscribers may be provided in advance with small charging pads 50 adhered exteriorly to the vehicle 20, and these charging pads bear a visual landing target. FIG. 4 is a perspective view of an exemplary charging pad 50 adhered exteriorly to the roof of vehicle 20. The charging pad 50 bears a visual landing target “H” and is an inductive charging pad connected to the vehicle electrical system. In executing its landing sequence, the UAV 4 hovers over the vehicle and deploys an image analysis software program that includes an H-pattern recognition algorithm. The software first samples selected video frames, sampling pixels at different data fuzzing levels until it finds the H. The software estimates proximity from the size of the H, and uses proximity and orientation data to land on the vehicle 20, using its local camera and thereby docking with the vehicle via the charging pad 50. The UAV may dock with the vehicle by forming a connection with the inductive charging pad 50 and hence vehicle 20. Alternately, if the subscriber has no adhesive charging pad, their roadside assistance application may instruct them to place their smart phone on the vehicle 20 and the smart phone itself will display the visual target for landing.

The subscriber is instructed via their roadside assistance mobile application what to do. For refueling the roadside assistance mobile application will instruct the motorist how to detach the fuel container from the UAV 4 and rebel and start a vehicle that has run out of gas. For charging an electric vehicle via pad 50 they may be instructed simply to wait. Alternatively they may be instructed to connect cables from pad 50 to their cigarette outlet, battery terminals or charge port. In another embodiment the motorist may be instructed how to remove the battery pack from the UAV and connect its on-board cables. The foregoing instructions may be by text and/or multimedia videos displayed on the smart device. Alternatively, the motorist application includes a direct videoconferencing feature to establish a direct two-way videoconference between the remote service provider and the motorist cell phone for two way live communication with a mechanic.

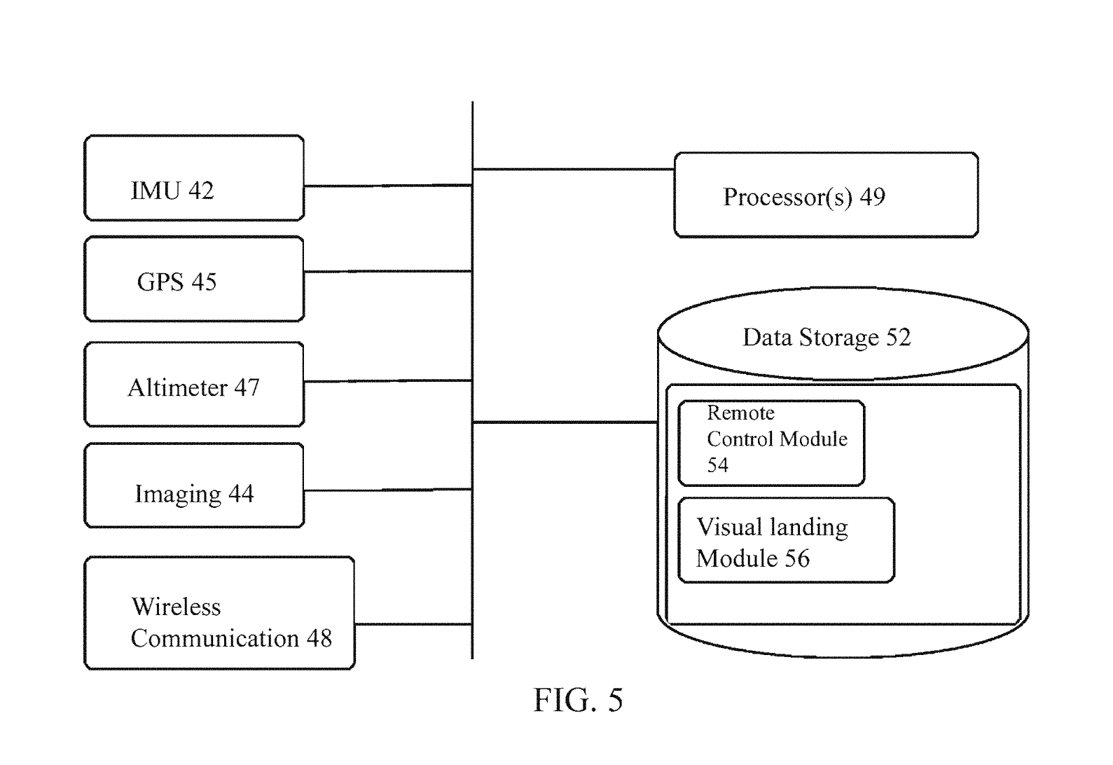

FIG. 5 is a simplified block diagram illustrating components of a UAV 4, according to an example embodiment. UAV 4 may include various types of sensors, and may include a computing system configured to provide the functionality described herein, in the illustrated embodiment, the sensors of UAV 4 include an inertial measurement unit (IMU) 42, Altimeter 47, GPS 45, and an imaging system 44. A wireless on-board communication system 48 is also provided. The sensors are in communication with one or more processors 49. Each processor 49 may be a general-purpose processor configured to execute software instructions stored locally in data storage 52, inclusive of a Remote Control Module 52 and a Visual Landing Module 54. The Remote Control Module 52 receives and executes navigation instructions transmitted from roadside assistance server 6 to wireless on-board communication system 48. At some predetermined threshold proximity determined by processor(s) 49 with reference to GPS 45 (e.g., ten feet above the vehicle 20), the processor 49 is programmed to switchover to the visual landing module 54 referenced above, which lands the UAV 4 atop the visual target. The data storage 52 comprises computer-readable storage media such as non-volatile optical, magnetic, organic or other memory or disc storage, which can be integrated in whole or in part with at least one of the one or more processors 49.

IMU 42 may include an accelerometer and a gyroscope to determine the orientation of the UAV 4. IMUS are commercially available.

Altimeter 47 may include a pressure sensor or barometer, which can be used to determine the altitude of the UAV 4.

UAV 4 also includes a GPS receiver 45. The GPS receiver 45 may be configured to provide data that is typical of well-known GPS systems, such as the GPS coordinates of the UAV 4.

UAV 4 also includes visual imaging system 44. For example, a high resolution POV video camera may be utilized by UAV 4 to capture image data for obstacle avoidance, ground tracking and image recognition and processing.

UAV 4 also includes a Communication System 48 including a wireless interface which allows UAV 4 to communicate via network 8. Such wireless interface may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. For example, Communication System 48 may provide a WiFi connection to roadside assistance server 6.

UAV 4 may navigate to the general area of the vehicle 20 using waypoints transmitted from roadside assistance server 6 based on GPS coordinates transmitted back to roadside assistance server 6. Once at the site the roadside assistance server 6 will guide the subscriber to install the docking pad 50 and then instruct UAV 4 to switch to visual landing mode. The UAV 4 will thereafter utilize image recognition to land on the pad 50.

The UAV 4 is also provided with one or more batteries for providing, power to the UAV 4.

The UAV 4 is provided with a one gallon container of emergency gas that is detachable from the underside of the UAV 4. The container is a conventional plastic can with internal spout calculated to provide at least a 5-mile emergency supply.

In addition, the UAV 4 is provided with a payload comprising a detachable 12-Volt Portable Car Jump starter/Battery Charger Power Pack of sufficient storage to jump a conventional car and to give an electric vehicle 20 such as a Tesla® a 5-mile emergency charge. For this the capacity of the battery unit may be at least 400 Watt hours, and may include at least four lithium-ion battery cells with a combined potential of 12 VDC. The apparatus may include a balancing system connected to the battery unit, where the balancing system includes a discharging circuit configured to, responsive to detecting a battery cell voltage of a predetermined voltage threshold, draw a constant charging current from the lithium-ion battery cells. The balancing system may draw the constant discharging current until detecting the battery cell voltage is below the predetermined voltage threshold. The balancing system is connected to an inductive charging system that applies an external time-varying magnetic field to charging pad 50.

Optionally, the UAV 4 may also be equipped with a tire inflator and the motorist is instructed via the motorist application how to inflate a flat tire. The UAV may also be equipped with a small reservoir for radiator fluid and the motorist is instructed via the motorist application on their cell phone how to fill the vehicle radiator that has overheated.

It should now be apparent that the above-described system is capable of dispatching roadside assistance to motorists using a network of unmanned aerial vehicles (UAVs) 4 via a simple requests for a dispatch using an application running on a smart phone. The dispatched UAV 4 is controlled from remote server 6 to follow a flight plan to the summoning motorist based on GPS location of their cell phone, and then land on a landing pad placed there by the motorist or alternatively on the cell phone. The landing pad doubles as an inductive charging station that uses an electromagnetic field to transfer energy to the vehicle by electromagnetic induction. Alternatively, the motorist is instructed via their cell phone how to connect cables. Either way the UAV delivers the charge necessary to jump the vehicle or provide an emergency recharge to its batteries.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A system for dispatching roadside assistance to motorists, comprising:
a plurality of unmanned aerial vehicles (UAVs), each UAV further comprising an emergency battery power supply connected to an inductive charger, an emergency detachable fuel supply, an imaging system and a visual landing software module configured to land the UAV on a predetermined target; and
an inductive charging pad electrically connected to a vehicle electrical system, said inductive charging pad bearing said predetermined target;
whereby a UAV may deliver a charge necessary to jump a vehicle or provide an emergency recharge.
